(19) United States
(12) Patent Application Publication
(10) Pub. No.: US 2009/0128299 A1
(43) Pub. Date: May 21, 2009

(54) APPARATUS AND METHOD OF RFID FREQUENCY ENCODING

(75) Inventors: Josef Kirmeier, Los Gatos, CA (US); Timothy K. Brand, Cupertino, CA (US)

Correspondence Address: FOUNTAINHEAD LAW GROUP, PC, 900 LAFAYETTE STREET, SUITE 509, SANTA CLARA, CA, 95050, US

(73) Assignee: Mu-Gahat Holdings Inc., Sunnyvale, CA (US)

(21) Appl. No.: 12/271,219

(22) Filed: Nov. 14, 2008

Related U.S. Application Data
(60) Provisional application No. 60/988,152, filed on Nov. 15, 2007.

(51) Int. Cl. H04Q 5/22

(52) U.S. Cl. 340/10.1

(57) ABSTRACT

In one embodiment the present invention includes a radio frequency identification (RFID) apparatus comprising an inlay layer. The inlay layer includes a plurality of resonant metal structures. The plurality of resonant metal structures has a first configuration of locations and resonate frequencies. Each resonant metal structure corresponds to a location and a resonant frequency.

### CROSS REFERENCE TO RELATED APPLICATIONS

The present application claims priority to U.S. Provisional Patent Application No. 60/988,152, titled “Apparatus and Method of RFID Frequency Encoding”, filed Nov. 15, 2007, the disclosure of which is incorporated herein by reference.

### BACKGROUND

The present invention relates to radio frequency identification (RFID) tags, and in particular, to chip-less passive RFID tags where their frequency response encodes their identification information.

Unless otherwise indicated herein, the approaches described in this section are not prior art to the claims in this application and are not admitted to be prior art by inclusion in this section.

Two general types of RFID tags exist: active tags and passive tags. Active tags are more expensive and generally include an antenna, a chip and a power source. Passive tags are generally less expensive and include an antenna and a chip. In both cases, the chip stores identification information that the RFID tag produces when interrogated by a reader.

There are a number of problems with chips that limit the applicability of RFID technology in certain areas. First, the cost of the chip is a significant portion of the cost of the entire RFID tag. Second, the form factor of the chip may be inappropriate for certain uses. For example, if the RFID tag is to be part of a thin object, the chip may produce a perceptible bump in the object.

Along these lines, traditional solutions include the gradual reduction in the cost of chips due to the gradual reduction of integrated circuit costs in general, as well as the gradual reduction in the size (e.g., thickness) of chips due to the gradual reduction of integrated circuit sizes in general. However, this gradual improvement has limited the deployment of RFID technology in certain areas, such as regarding gaming cards, consumer packaging, mail, and tickets.

Thus, there is a need for an improved RFID tag. The present invention solves these and other problems by providing an RFID tag that uses a range of frequencies for encoding its identification information.

### SUMMARY

Embodiments of the present invention improve apparatus and methods for RFID frequency encoding. In one embodiment the present invention includes a radio frequency identification (RFID) apparatus comprising an inlay layer. The inlay layer includes a plurality of resonant metal structures having a first configuration of locations and resonant frequencies. Each resonant metal structure has a location and a resonant frequency.

In one embodiment the resonant metal structures include at least one metal loop.

In one embodiment the resonant metal structures include a plurality of metal extensions emanating from alternating regions of the at least one metal loop. The plurality of metal extensions form a distributed capacitance along the alternating regions of the metal loop. Alternatively, the resonant metal structures may include an open circuit coil.

In one embodiment the inlay layer includes a metal foil with a plurality of cavities without metal such that the metal forms the plurality of resonant metal structures.

In one embodiment, the invention further comprises an RFID reader. The RFID reader has a plurality of metal loops. Each metal loop has a location. Each metal loop induces a magnetic field.

In one embodiment each metal loop of the RFID reader is coupled to an electrical source. The electrical source multiplexes between each metal loop

In one embodiment the electrical source sweeps over a range of frequencies while sourcing an electrical signal to at least one metal loop of the RFID reader.

In one embodiment the frequencies include discrete frequencies.

In one embodiment the RFID reader is enabled when the inlay layer moves proximate with the plurality of resonant structures

In one embodiment a magnetic field couples to at least one resonant metal structure of the plurality of resonant metal structures. The at least one resonant metal structure has a location corresponding to a location of a metal loop of the RFID reader which induces the magnetic field. The magnetic field has a frequency corresponding to a resonant frequency of the at least one resonant metal structure.

In one embodiment the metal loop of the RFID reader is coupled to an electrical source. The at least one resonant metal structure provides a load on the electrical source when the electrical source is generating the resonant frequency.

In one embodiment the RFID reader detects the change of load on the electrical source when the resonant frequency of the at least one resonant metal structure is generated.

In one embodiment the metal loop of the RFID reader is coupled to an electrical source. The RFID reader further includes a second metal loop that senses magnetic fields.

In one embodiment the RFID reader detects the change of received magnetic flux at the second metal loop when the resonant frequency of the at least one resonant metal structure is generated from the electrical source and the resonant metal structure couples the magnetic field to the second metal loop.

In one embodiment the invention includes a method of performing radio frequency identification (RFID), comprising the steps of moving a plurality of resonant structures proximate with an RFID reader, reading a reader configuration code, retrieving a reader configuration file, configuring the RFID reader according to the second configuration, reading an identification number, retrieving client information, and moving the plurality of resonant structures away from the RFID reader. The plurality of resonant structures has a first configuration of locations and frequencies. The step of reading a reader configuration code uses the RFID reader. The reader configuration code corresponds to at least one resonant structure of the plurality of resonant structures. The reader configuration file corresponds to the reader configuration code. The reader configuration file contains information regarding a second configuration of location and frequencies. The step of reading an identification number uses the RFID reader. The identification number corresponds to the first configuration and the second configuration. The step of retrieving client information corresponds to the identification number.

In one embodiment the step of reading the identification number includes transmitting a plurality of electromagnetic fields provided by a plurality of metal loops of the RFID reader. Each electromagnetic field of the plurality of electromagnetic fields includes a frequency corresponding to the second configuration. Each metal loop has a location corresponding to the second configuration. The step of configuring the RFID reader includes programming at least one electrical source according to the second configuration.

The following detailed description and accompanying drawings provide a better understanding of the nature and advantages of the present invention.

### BRIEF DESCRIPTION OF THE DRAWINGS

FIG. 1 is a top view (cut away) of a card according to an embodiment of the present invention.

FIG. 2 is a cut away side view (enlarged) of the card of FIG. 1.

FIG. 3 is a frequency graph showing a portion of a frequency response of an embodiment of the present invention.

FIG. 4 shows a top view of resonant circuits according to an embodiment of the present invention.

FIG. 5 illustrates a system according to one embodiment of the present invention.

FIG. 6 illustrates a method according to one embodiment of the present invention.

FIG. 7 illustrates an identification system according to several embodiments of the present invention.

FIGS. 8A-8B illustrate a resonant metal structure and a layout of an inlay layer according to one embodiment of the present invention.

FIGS. 9A-9B illustrate another resonant metal structure and a layout of an inlay layer according to another embodiment of the present invention.

FIGS. 10A-10B illustrate a card with a magnetic strip according to an embodiment of the present invention.

FIGS. 11A-11B illustrate square resonant structures according to an embodiment of the present invention.

### DETAILED DESCRIPTION

Described herein are techniques for RFID frequency encoding. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In the following description, the presence of a particular frequency is used to indicate a binary “1”, and the absence of a particular frequency is used to indicate a binary “0”. However, such usage is only for convention. A particular embodiment may use, for example, the absence of a particular frequency to indicate a binary “1”.

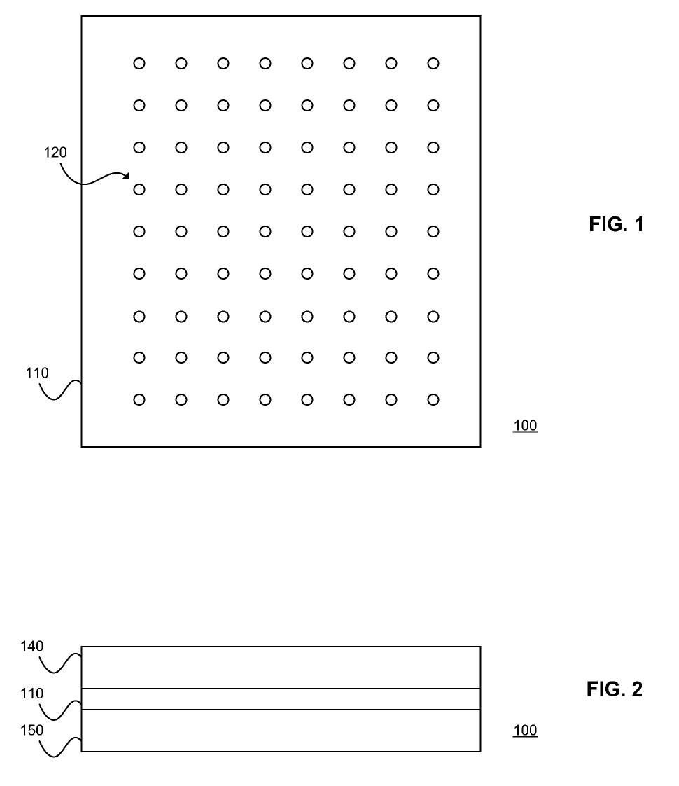

FIG. 1 is a top view (cut away) of a card 100 according to an embodiment of the present invention. The card 100 includes an RFID inlay layer 110 and numerous resonant circuits 120 on the RFID inlay layer 110. The resonant circuits 120 each include an inductive element and may also include a capacitive element. In response to radio frequency energy, for example from an RFID reader (not shown), the resonant circuits 120 resonate and thereby communicate their presence to the RFID reader. The value of each combination of inductive elements and capacitive elements differs for each of the resonant circuits 120, so each of the resonant circuits 120 resonates at a different frequency. The inductive element, the (optional) capacitive element, or both may not be discrete elements. For example, the inductive element may be a metal coil cut or stamped out from a foil sheet and the capacitance may be an inherent or parasitic capacitance.

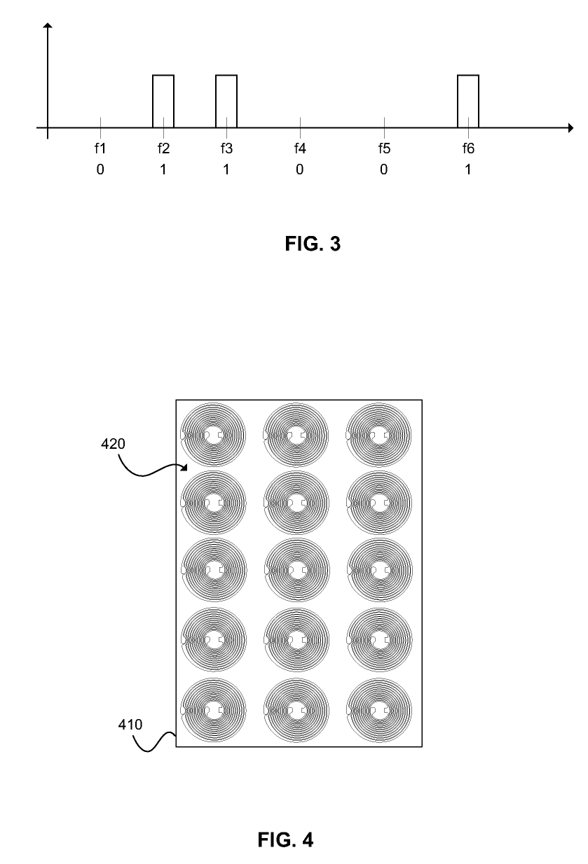

FIG. 2 is a cut away side view (enlarged) of the card 100 (see also FIG. 1). The card 100 includes the RFID inlay layer 110, a top card layer 140, and a bottom card layer 150. The RFID inlay layer 110 includes the resonant circuits 120 (not shown, see FIG. 1). The RFID inlay layer 110 may have a thickness appropriate for cards, for example, approximately 52 microns.

The top card layer 140 and the bottom card layer 150 provide the visual, tactile and structural functions of the card 100. The top card layer 140 and the bottom card layer 150 may have a thickness appropriate for cards, for example, 95 microns.

As such, the card 100 may have a total thickness of approximately 150 microns.

The inlay layer 110 may include a metal foil cavity made by laser ablation. For example, a laminated sheet or strip may include a dielectric material and a metal layer. A laser may ablate portions of the metal layer, leaving the cavity structure 220 on the dielectric sheet or strip. Materials similar to those discussed below with reference to FIG. 4 may be used.

FIG. 1 shows 72 resonant circuits 120. Each of the resonant circuits 120 may resonate at a different frequency, so the RFID inlay 110 as shown indicates the presence of 72 different frequencies as an example. The number of frequencies can vary with the number of required bits depending upon the information desired to be stored. The encoding can be position dependent or independent. Also the position can be part of the encoding. In order to encode information on other RFID inlays (not shown), certain of the resonant circuits 120 may be omitted. For example, the 72 frequencies of the RFID inlay 110 may be represented by a string of 72 “1”s: 111111111111111111111111111111111111111111111111111111111111111111111111

Another RFID inlay (not shown) may be identified by another string of 72 bits: 111011011111101111101110111111101100111010111111101111111110110011101111

As the above string has 57 “1”s (and 15 “0”s), 57 resonant structures may be formed on the RFID inlay.

Thus, with 72 bits, 2 [symbol] 72 separate identification combinations are available for all the RFID inlays having a similar size and type of resonant circuit. (This is approximately 4.7 billion trillion combinations.)

For a card embodiment, the 72 bits may correspond to the following information:

Continent identifier: 2 bits
Casino chain identifier: 16 bits
Card type identifier: 6 bits
Manufacturing date identifier: 16 bits
Serial number identifier: 32 bits

Although 72 bits give approximately 4.7 billion trillion combinations, not all the combinations are required to be used. For example, the used combinations may be limited to those with, for example, 26 or fewer resonant circuits. This allows the manufacturing costs to be reduced (as compared to implementing more than 26 resonant circuits) while still allowing a large number combination space.

More specifically, although space may be provided for 72 resonant circuits, on average a particular bit string may include only 26 “1”s and hence only require 26 resonant circuits. For a particular bit string with a large number of “1”s, a further embodiment may include a parity bit. When the presence of the parity bit (frequency) is detected, instead of the presence of a particular frequency indicating a “1”, the presence of a particular frequency may indicate a “0”. So for example using the example bit string above with 57 “1”s and 15 “0”s, the first “1” may be the parity bit, in which case only the 15 resonant circuits corresponding to the 15 “0”s need be formed on the RFID inlay. In general, the specific encoding process may be selected from a theoretically infinite number of encoding processes; the specific process chosen may be selected based on the maximum number of combinations desired, the desired size of the resonant circuits, and the available space for the resonant circuits.

Two or more resonant circuits may create side band frequencies. A resonant circuit may have secondary resonant frequencies. The presence of side band or secondary frequencies may be used to establish bits as well.

FIG. 3 is a frequency graph showing a portion of a frequency response of an embodiment of the present invention. For illustration purposes, six frequencies f1, f2, f3, f4, f5 and f6 are shown. The resonant circuits corresponding to the frequencies f2, f3 and f6 are responding, and there is no response on the frequencies f1, f4 and f5. The overall response may be represented by the following bit string (where “0” may represent the absence of a resonant circuit):

011001

The lowest frequency may correspond to the most significant (or leftmost) bit, and the highest frequency may correspond to the least significant (or rightmost) bit. Alternatively, the highest frequency may correspond to the most significant (or leftmost) bit, and the lowest frequency may correspond to the least significant (or rightmost) bit. Or alternatively, some other defined scheme may be used for mapping the particular frequencies to particular bit positions. As mentioned above, the specific scheme chosen may be position dependent or position independent.

The particular frequencies used in embodiments of the present invention may be selected according to various criteria as follows. One criterion is the type of resonant structure selected. For example, for the embodiment of FIG. 1, a frequency range of between about 500 MHz and 1.0 GHz may be used, as this frequency range works when 72 resonant circuits 120 are in the card 100. Alternatively, a frequency range of between about 1 MHz and 72 MHz may be used.

The frequency range to be used in a particular embodiment may be selected according to various design tradeoffs. For example, for frequencies from 20 MHz to 200 MHz, more than 180 bits may be stored if each bit has a bandwidth of less than 500 kHz and leaving about 500 kHz as a separator. In UHF for instance, the required bandwidth may be higher because of the higher bandwidth of each frequency. The required bandwidth is a matter of the Q factor of the resonant circuits, which is determined by F/ΔF@-3 dB. So for example at a Q of 50, the required bandwidth per frequency at 1 GHz would be 1 GHz/50=MHz, plus 1 MHz separation, and so on.

The cards 100 may be used as part of an RFID gaming system. The gaming system may include, for example, a gaming table that has an RFID reader in proximity to the card play surface. For example, the RFID reader may be approximately 5 mm below the card play surface, thus a low power interrogation signal may be used to read the card 100 or 200. The field strength may be on the order of microwatts or milliwatts, thereby allowing unlicensed frequency use across a wide frequency band.

The RFID reader may step through each frequency individually, or it may perform a multitone burst interrogation.

FIG. 4 shows a top view of resonant circuits according to an embodiment of the present invention. FIG. 4 shows fifteen resonant circuits 420 arranged on a RFID inlay layer 410. As discussed above, if fifteen resonant circuit combinations are selected, this provides 2 [symbol] 15 combinations (which is 32,768 combinations). The RFID inlay layer 410 may be incorporated into a card (as discussed above), for example.

The RFID inlay layer 410 may be manufactured by the following process. A laminated sheet or strip that includes a metal layer and a dielectric layer is provided. A laser ablates portions of the metal layer, leaving the inductive coil 420 on the dielectric sheet or strip. (Multiple coils may be formed in this manner on the same dielectric sheet or strip, if desired.)

The metal layer on the laminated sheet or strip may be aluminum or copper, for example, depending upon the frequency range. The dielectric layer may be for example polyvinyl chloride (PVC) or polyethylene terepthalate (PET).

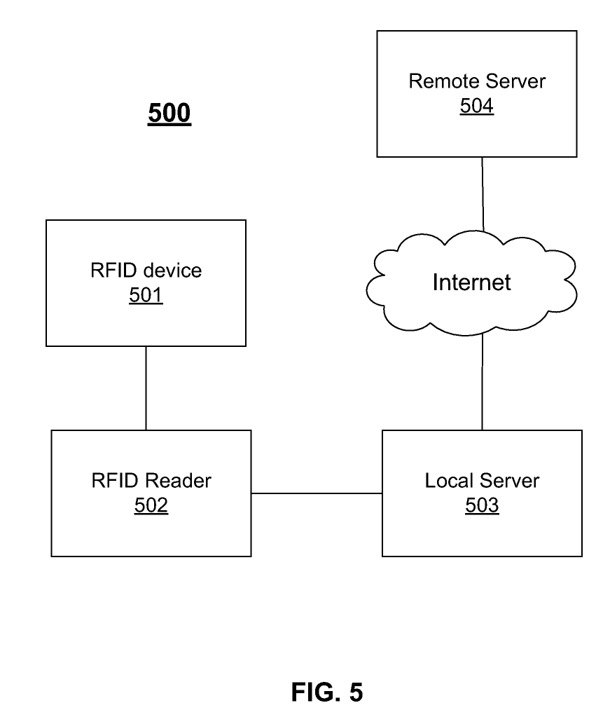

FIG. 5 illustrates a system 500 according to one embodiment of the present invention. The system 500 includes an RFID device 501, an RFID reader 502, a local server 503, and a remote server 504. RFID device 501 may be a device which contains an inlay layer having a plurality of resonant structures (for example see FIG. 4). This RFID device 501 may be an identification card. RFID reader 502 may have a plurality of sources. The sources may be able to detect different frequencies including side bands. The local server 503 is coupled to the RFID reader so that it may configure the RFID reader. Configuring may include programming the various sources. Each source may be programmed to transmit a particular frequency. Each source may be programmed to detect a particular frequency. The local server may utilize a reader configuration file in order to program each source having a particular location, a particular transmitted signal having a particular frequency content, and a frequency to detect. In addition, the local server 503 may perform an initial detection in a limited area or on a limited number of frequencies, and based on the initial detection, may select a particular configuration file, and then perform wider readings according to the selected configuration file.

A remote server 504 may have access to a database of configuration files and access to a database of client information. The local server 503 may retrieve a reader configuration file from the remote server 504 through the internet, a secure network, or both. The configuration files may be organized according to card types. For example, one credit card may have a different configuration than a credit card from a different financial institution. The remote server may also have access to a database of client information. This information may include identification photographs, verification questions, and account information.

A user may move the RFID device 501 proximate with the RFID reader 502. This may begin a process in which the RFID reader 502 reads a configuration code. The configuration code may include reading at least one of the resonant structures. The configuration code may be passed to the local server who utilizes the configuration code to retrieve a configuration file from the remoter server 504. The configuration file may be used to program the RFID reader 502 in a configuration corresponding to the configuration code. After the configuration of the RFID reader 502 has been accomplished the sources may transmit electromagnetic signals in a configuration according to the configuration file, and the RFID reader 502 may detect particular frequencies according to the configuration file. The RFID reader 502 may correlate the configuration of the plurality of resonant structures of the RFID device 501 with the configuration of the RFID reader 502. The instances (location and frequency) that match and instances (location and frequency) that do not match between the RFID device 501 configuration and the RFID reader 502 configuration may form a digital code. This digital code may correspond to an identification number.

The identification number may be determined by the local server 503 according to some coding scheme or may simply be determined in the reader and passed to the local server 503. The local server 503 may utilize the identification number to retrieve client information from the remote server 504. The RFID device 501 may be an identification card, and the client information may be a picture and verification information such as account information, for example. In one embodiment, the RFID device 501 contains only a configuration code and an identification number, and when the RFID device 501 is moved away from the reader all of this information as well as any client information is deleted from the local server 503. Also the RFID reader 503 may be reset such that the reader configuration information is deleted as well.

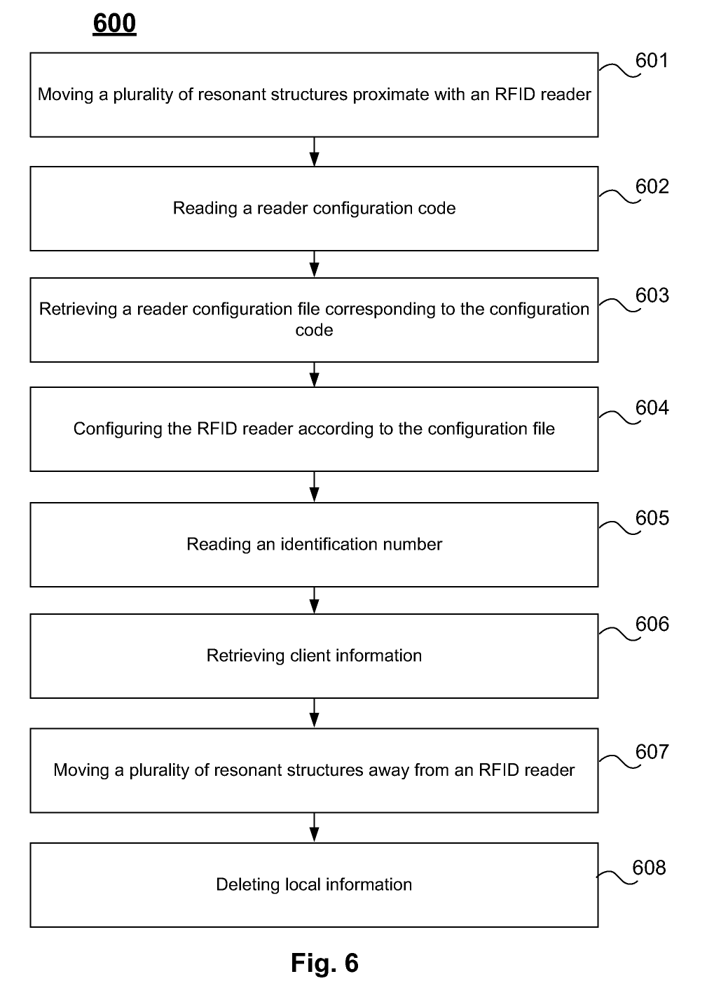

FIG. 6 illustrates a method 600 according to one embodiment of the present invention. The method 600 may be implemented in part as a computer program that is executed by one or more processing devices.

At 601, a plurality of resonant structures are moved proximate with an RFID reader. The resonant structures may be circuits as mentioned above. The resonant structures may be part of an inlay layer as mentioned above. The location and resonant frequencies of the plurality of resonant structures may form a card configuration. The configuration may be unique and may have an identification number encoded as mentioned above. The resonant structures may be part of an identification card. The resonant structures, as part of a structure that includes them, may come in contact with a surface of the RFID reader.

At 602, the reader configuration code is read. This may be done manually by an operator who may enter the code which may have been sent with a lot of cards which require the configuration designated by the configuration code. The configuration code may also be automatically read from one or more of the resonant structures using a set of predetermined frequencies and locations provided by the reader.

At 603, the configuration file is retrieved corresponding to the configuration code. Again this may be done manually by an operator. The operator may look up the code on a secure internet website. Alternatively, the configuration file may be retrieved automatically from a remote server using the configuration code. This may include retrieving the data over the internet using a secure connection. The retrieving may include creating a local copy of the configuration file on a local server.

At 604, the RFID reader is configured according to the configuration file. This may include programming RF sources with particular frequencies at particular locations. This may include programming the RFID reader to detect particular frequencies at particular locations. Note that 602, 603 and 604 may be performed more than once in a looping manner. That is, a first configuration code is read; a first configuration file is retrieved; the RFID reader is configured according to the first configuration file; a second configuration code is read; a second configuration file is retrieved; and the RFID reader is configured according to the second configuration file.

At 605, the identification number is read. This may include correlating the card configuration with the RFID reader configuration. A location may match when the resonant structure draws power from the RFID source of the RFID reader. The locations that match and the locations which do not match may be used to form a digital code. An example of this encoding has been described above. The digital code may correspond to the identification number directly or may be encoded further. Side band frequencies may by used with are generated by the card configuration when exposed to the plurality of RFID sources on the reader. In this embodiment the reader configuration file may include source frequencies and detection frequencies. The detection frequencies may be side band frequencies generated by a combination of two or more resonant structures responding to signals provided by the programmed sources of the RFID reader.

At 606, the client information is retrieved. This may be accomplished by sending the identification over the internet and retrieving the client information from a remote server with access to a client database. The client information may include a digital identification photograph, client transaction history, client authorization, client records, or any combination herein.

At 607, the plurality of resonant structures are moved away from the RFID reader. This may signal the end of a transaction, an operation, or both.

At 608, the local information is deleted. This may include a local copy of the configuration file, a local copy of the configuration code, a local copy of the client information, or any combination herein. Step 608 may be in response to step 607.

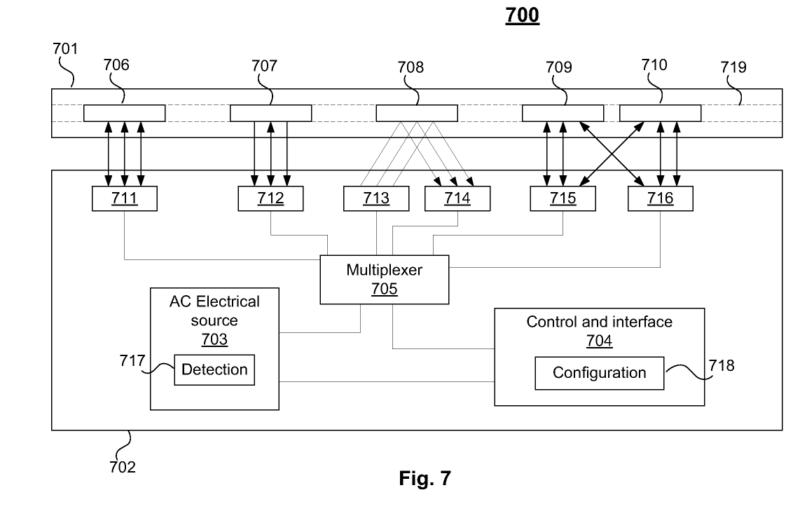

FIG. 7 illustrates an identification system 700 according to several embodiments of the present invention. The identification system 700 includes an identification card 701 and a RFID reader 702. Identification card 701 includes an inlay layer 719 comprised of resonant metal structures 706-710. Each resonant metal structure has a location and at least one resonant frequency. The RFID reader 702 includes metal loop 711-716, a multiplexer 705, an electrical source 703, and a control interface circuit 704. The electrical source may have a detection circuit 717 to detect changes in the loading of the electrical source 703. The multiplexer 705 couples the electrical source 703 to the individual metal loops 711-716. The control interface circuit 704 is coupled to control the multiplexer 705 and the electrical source 703 such that the resonant metal structures 706-719 may be detected.

In one embodiment, the controller may execute a routine to instruct the multiplexer 705 to connect the electrical source 703 to metal loop 711 and sweep through a range of discrete frequencies (symbols). The metal loop 711 induces a magnetic field at the discrete frequencies. The electrical source 703 may detect that a particular frequency loads the electrical source 703. The loading of the electrical source at the particular frequency may indicate the magnetic field has coupled to the resonant metal structure. This particular frequency may be interpreted as the resonant frequency of the resonant metal structure 706. This detection of the symbol may be communicated to the controller interface circuit 704.

In another embodiment, the resonant metal structure 707 and metal loop 712 couple at a resonant frequency and a secondary resonant frequency. In this case the detection circuit 717 has detected more than one resonant frequency when the electrical source has swept across a set of discrete frequencies. This resonant signature may be determined by the detection circuit 717 or by the control interface circuit 704. This embodiment may require the detection circuit 717 to detect weak resonant signals as well.

In another embodiment resonant metal structure 708 couples a magnetic field between metal loops 713 and 714. In this case metal loop 713 has induced a magnetic field. The electrical source once again sweeps across a discrete set of frequencies. When the resonant frequency of resonant metal structure 708 is reached the resonant metal structure 708 couples the magnetic field to metal loop 714. The increase in power being transferred to metal loop 714 may be detected and registered as a detection of that resonant frequency. In this example, the detection circuit 717 may be different than the detection involved with the previous embodiments. In this embodiment, the detection may require an additional coupling of metal loop 714 to the detection circuit 717.

In another embodiment resonant metal structure 709 and 710 are provided with magnetic fields from metal loops 715 and 716, respectively. In this case, the magnetic field coupled by resonant metal structure 709 and metal loop 715 interact with the magnetic field coupled by resonant metal structure 710 and metal loop 716. This interaction may generate side bands which may be coupled to metal loop 715 and metal loop 716. In this case, the electrical source 703 may need to provide an electrical signal to metal loop 715 and to metal loop 716 simultaneously. The frequency of the two electrical signals may not be the same frequency.

The control interface circuit 704 may include a configuration 718. Configuration 718 may be downloaded from a remote internet site and may configure the control interface circuit 704 to control the electrical source 703 to sweep through a set of discrete frequencies. This configuration may indicate a set of frequencies corresponding to particular locations.

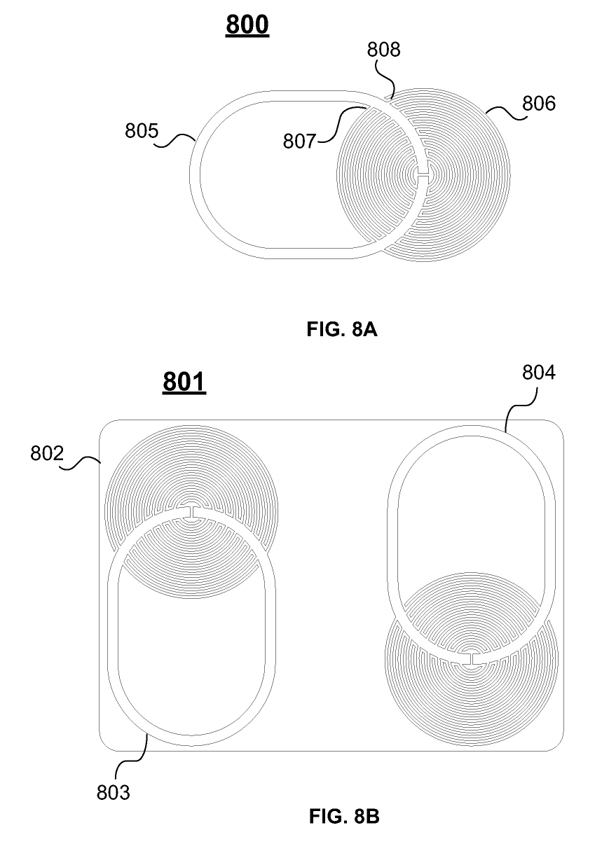

FIGS. 8A and 8B illustrate a resonant metal structure 800 and a layout 801 of an inlay layer 802 according to one embodiment of the present invention. The inlay layer 802 has a configuration of resonant metal structures (803, 804). The resonant metal structure 800 includes an inductor and a capacitor in parallel. The inductor is formed from a metal loop 805 which is oblong and oval. The capacitor is formed from a circular structure 806 made up of a plurality of metal extensions emanating from alternating regions of the metal loop 805. The plurality of metal extensions forms a distributed capacitance along the alternating regions of the metal loop. The metal loop 805 shape may be any number of shapes and have any number of loops. The size and number of loops as well as any material used to encase the inlay layer as described above may influence the resonant frequency of the resonant metal structure.

The inlay layer 802 may be encased into a baccarat card. Each card may have a unique inlay layer 802 which has a unique combination of resonant metal structures (803,804). The inlay layer is approximately the size of a standard playing card (62 mm×88 mm). The longest dimension of one of the resonant structures 803 is approximately 60 mm. The unique combination may be formed by location and resonant frequency. For example, TABLE 1 below shows how successively cutting off the extensions emanating from the metal loop may change the resonant frequency of the resonant metal structure 800. Cutting the extensions from the circular structure 806 changes the capacitance of the resonant metal structure 800. Extension 807 is an example of an inside extension relative to the metal loop 805. Extension 808 is an example of an outside extension relative to the metal loop 805.

TABLE 1

| | | Resonant |
|---|---|---|
| Number of | Number of outside | Frequency |
| inside cuts | cuts | (Mhz) |
| 0 | 0 | 122 |
| 2 | 0 | 137.75 |
| 4 | 0 | 151.25 |
| 6 | 0 | 162.5 |
| 6 | 2 | 167 |
| 6 | 4 | 180.5 |
| 6 | 6 | 196.25 |
| 8 | 8 | 221 |
| 8 | 8 | 230 |
| 10 | 8 | 275.5 |
| 10 | 10 | 306.5 |
| 12 | 10 | 338 |

The frequencies may be theoretically calculated, characterized, or measured. The final resonant frequency may shift when the inlay layer is encased as described above. The frequency shift may be due to the dielectric properties of the material used to encase the inlay layer.

FIG. 8B illustrates a layout 801 of the inlay layer 802 of a baccarat card utilizing two resonant metal structures (803, 804). Resonant metal structure 803 is rotated 180 degrees from resonant structure 804. This may be put the resonant structures on a diagonal so that the baccarat cards may be more easily read facing at 0 degrees or rotated 180 degrees. In the case in which the cards would only face up or only face down the RFID reader would also have metal loops along a parallel diagonal. In the case in which the cards may face up or down the metal loops may be placed in a center most region to allow for a large amount of tolerance in the placing of the cards. If 10 symbols (frequencies) are used with the 2 locations we have 10²=100 theoretical possibilities. However, many combinations will repeat as reciprocals of other combinations and since we cannot determine the orientation in which a user places the card we must discount these reciprocal combinations. The combinations with symmetrical entries may be kept. For example, a combination of (f1,f2) may look exactly like (f2,f1) reversed, but a combination (f1,f1), (f2,f2), etc. will operate in either orientation. TABLE 2 below shows how a few example cards may be coded with frequency and location.

TABLE 2

| | | First | Second |
|---|---|---|---|
| Card | Card | location | location |
| Value | Suit | Frequency | Frequency |
| Ace | Hearts | f1 | f1 |
| 2 | Hearts | f1 | f2 |
| 3 | Hearts | f1 | f3 |
| 4 | Hearts | f1 | f4 |
| 5 | Hearts | f1 | f5 |
| 6 | Hearts | f1 | f6 |
| 7 | Hearts | f1 | f7 |
| 8 | Hearts | f1 | f8 |
| 9 | Hearts | f1 | f9 |
| 10 | Hearts | f1 | f10 |
| Jack | Hearts | f2 | f2 |
| Queen | Hearts | f2 | f3 |
| King | Hearts | f2 | f4 |
| Ace | Clubs | f2 | f5 |
| 2 | Clubs | f2 | f6 |
| 3 | Clubs | f2 | f7 |
| 4 | Clubs | f2 | f8 |
| 5 | Clubs | f2 | f9 |
| 6 | Clubs | f2 | f10 |
| 7 | Clubs | f3 | f3 |
| 8 | Clubs | f3 | f4 |
| 9 | Clubs | f3 | f5 |
| 10 | Clubs | f3 | f6 |
| Jack | Clubs | f3 | f7 |

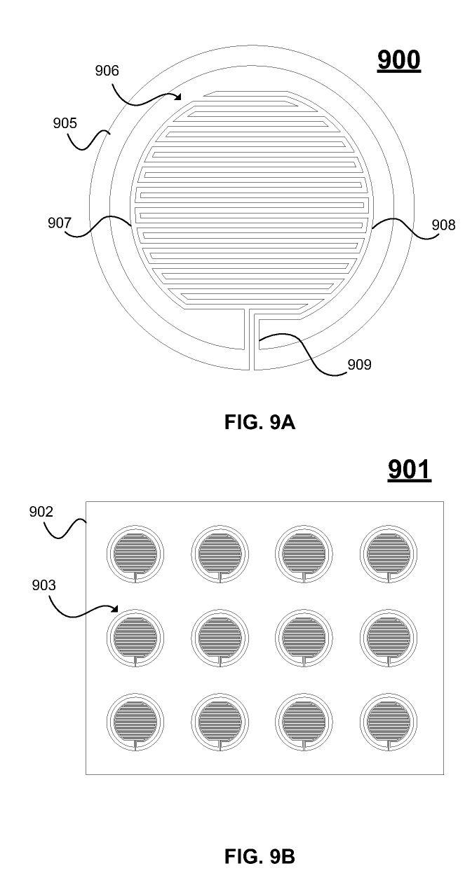

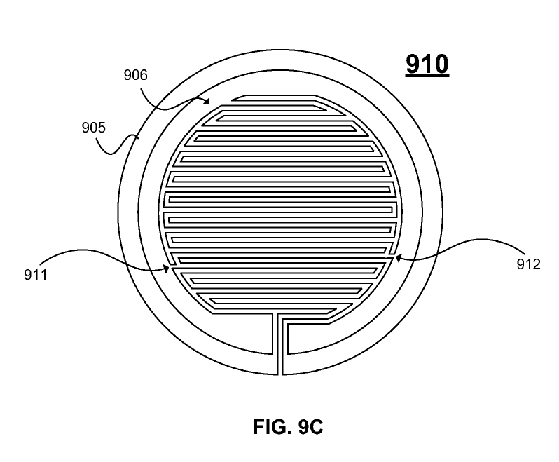

FIGS. 9A and 9B illustrate another resonant metal structure 900 and a layout 901 of an inlay layer 902 according to another embodiment of the present invention. The inlay layer 902 has a configuration of the metal resonant structures. The metal structure 900 includes an inductor and a capacitor in parallel. The inductor is formed from a circular loop 905. The capacitor is formed from a circular structure 906 made up of linear extensions which alternated from two sides of a left arch 907 and right arch 908 of conductive material. Resonant metal structure 901 may be trimmed similar to resonant structure 800 of FIG. 8 previously described. The extensions may be removed to the design in order to change the capacitance of the resonant metal structure 900. Alternately the size and shape of the circular loop may be altered to change the inductance of the resonant metal structure 900.

Resonant metal structure 900 responds primarily to a fundamental resonant frequency. The table below shows 9 symbols (frequencies) which the resonant metal structure 900 may be altered by the removing of extensions of the circular structure 906. FIG. 9C illustrates an example resonant metal structure 910 which represents symbol 3 in TABLE 3 below. Example resonant metal structure 910 has a gap in the metal at location 911 and location 912. Example resonant metal structure 910 was approximately 15 mm in diameter for the measurement take for TABLE 3 below.

TABLE 3

| | Frequency |
|---|---|
| Symbol | (Mhz) |
| 1 | 345 |
| 2 | 374 |
| 3 | 394 |
| 4 | 459 |
| 5 | 489 |
| 6 | 573 |
| 7 | 732 |
| 8 | 930 |
| 9 | 1200 |

The frequency may be made by altering the size of the entire resonant metal structure 900, by removing portion of the structure (e.g. example resonant metal structure 910), by resizing a portion of the resonant metal structure 900, or any combination herein.

The resonant metal structure 900 also has a weaker resonant response than resonant metal structure 800 of FIG. 8. This may be due to the channel 909 of resonant metal structure 900. The capacitance of resonant metal structure 900 is not distributed and the electrons during excitation at the resonant frequency need to move through channel 909. This channel and the circular structure 906 may also contribute to alternate resonant frequencies. These alternate resonant frequencies may comprise a signature for the resonant metal structure and may be utilized for symbol identification as well.

Layout 901 includes an inlay layer 902 and an array of resonant metal structures 903. The resonant structures 903 may also be open loop structures. The resonant structures 903 may be similar to those shown in FIG. 4, FIG. 9A, or FIG. 9C. The inlay layer 902 may be part of an identification card. There are 12 locations on the layout 901 and with 9 symbols (frequencies) as shown in the table above (9¹² combinations). The usable combinations depends if the card may be read in other orientations. Similar to previous embodiments the number of possible combinations may be reduced when other orientations are permissible.

Although embodiments of the present invention have been described with particular reference to cards, similar techniques may be applied to other RFID applications. Such RFID applications include consumer goods tracking such as with grocery products (in addition to or in place of the bar code, for example), event ticketing (in addition to or in place of the bar code, for example), mail processing (in addition to or in place of the stamp or routing identifier, for example), medical applications (blister pack or other packaging identification, for example), or security applications (identification cards, certificates, or document verification, for example).

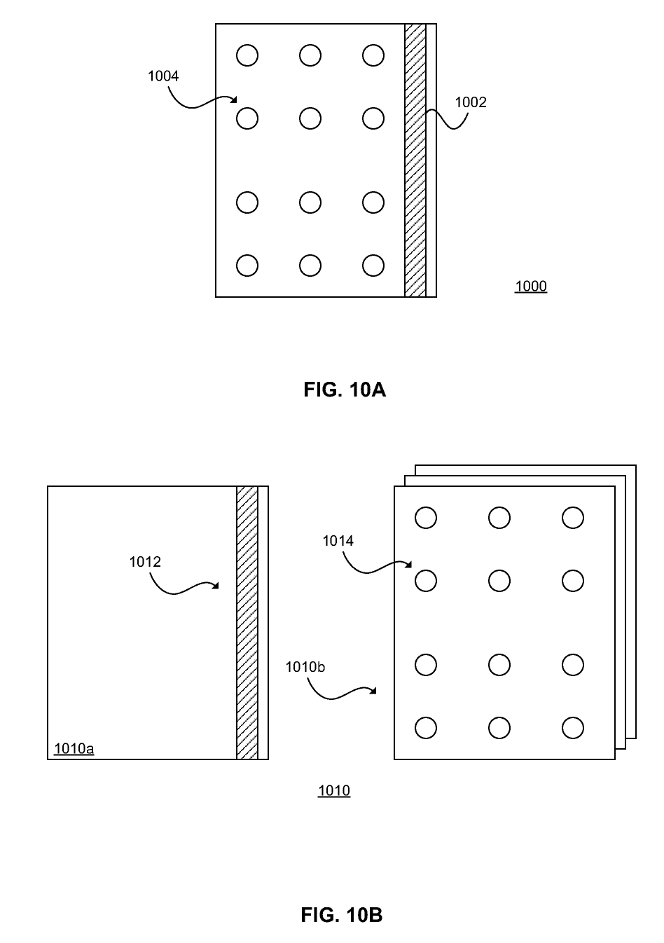

FIGS. 10A-10B illustrate a card with a magnetic strip according to an embodiment of the present invention. FIG. 10A illustrates a card 1000 that includes a magnetic strip 1002 and a number of resonant structures 1004. FIG. 10B illustrates a set of cards 1010. One card 010a includes a magnetic strip 1012. One or more of the remainder of the cards (e.g., 1010b) includes a number of resonant structures 1014. The resonant structures 1004 and 1014 may correspond to the resonant structures described above (see, e.g., FIG. 4 or FIG. 9). The magnetic strips 1002 and 1012 may be a magnetic strip as is found on credit cards, transit passes, etc., as appropriate given the structural attributes of the cards 1000 or 1010.

The card 1000 may be used in an environment in which an increased level of security is desired. For example, more information per unit area may be stored in the magnetic strip 1002 than in the resonant structures 1004. For example, the magnetic strip 1002 may store the configuration code, and the resonant structures 1004 may store the identification number (see FIG. 6). An attacker could read the magnetic strip 1002 yet still be unable to read the identification number.

The cards 1010 may be used in a gaming environment in which an increased level of security is desired. For example, the card 1010a may be used to identify that particular set of cards 1010 by configuring the reader (see FIG. 6). The remainder of the cards (e.g., 1010b) may then be read according to the configured frequencies (see, e.g., TABLE 2). If an attacker substituted a card not from the set 1010, for example a foreign Ace of Clubs, the foreign card would not be recognized as a valid card; the invalid card may then be identified and removed, increasing the integrity of the game.

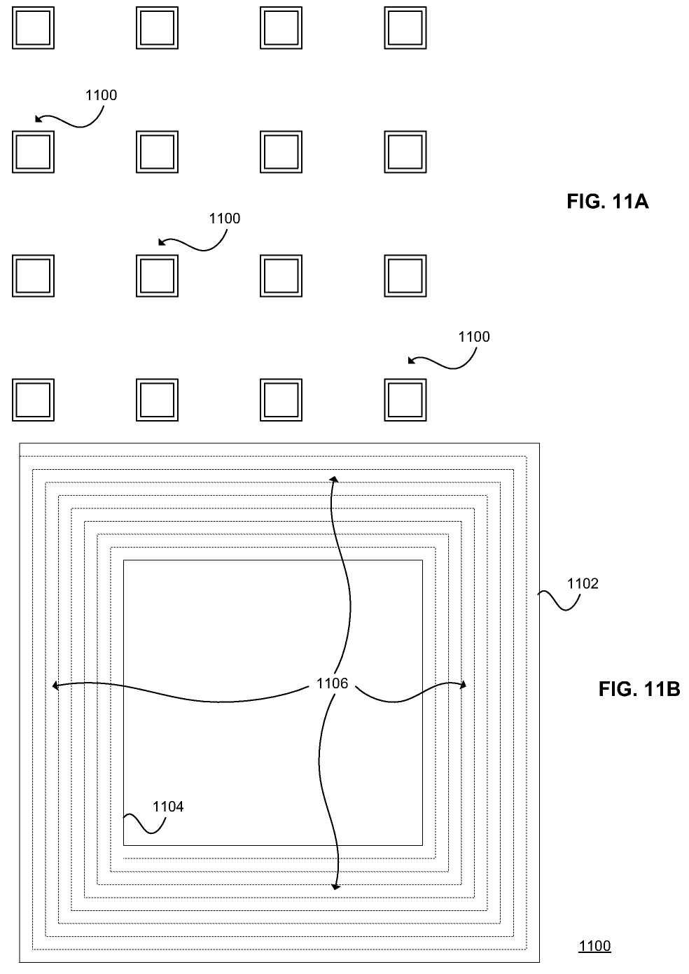

FIGS. 11A-11B illustrate square resonant structures 1100 according to an embodiment of the present invention. FIG. 11A shows sixteen resonant structures 1100 in a grid arrangement. FIG. 11B shows an enlarged resonant structure 1100. The resonant structure 1100 may be used in addition to, or in place of, the resonant structures described above (e.g., FIG. 4 or FIG. 9).

Each resonant structure 1100 has an outer dimension of one centimeter. The spacing between each of the resonant structures 1100 is two centimeters. The resonant structure 1100 has an outer edge 1102, an inner edge 1104, and a coil 1106. The coil 1106 has 7.75 turns.

The resonant structures 1100 may be fabricated from various conductive materials, with varying sizes, with varying trace widths, and with varying thicknesses. The trace width together with the metal thickness determents the impedance and therefore the Q of the inductive structure. For example, the resonant structures 1100 can be fabricated from aluminum having a thickness of 2 microns. As another example, the resonant structures 1100 can be fabricated from copper having a thickness of 3 microns and a trace width of 6 microns. The resonant structure 1100 resonates at 330 MHz.

TABLE 4 shows resonant frequencies of the resonant structure 1100, with changing the number of turns, according to various embodiments of the present invention. (The other parameters of the resonant structures 1100 are similar.)

TABLE 4

| | Resonant frequency (derived | |
|---|---|---|
| | from theoretical model, | Resonant frequency |
| Turns | MHz) | (measured, MHz) |
| 1.75 | 1030 | not fabricated |
| 2.75 | 666 | 630 |
| 3.75 | 520 | 495 |
| 4.75 | 439 | 420 |
| 5.75 | 384 | 375 |
| 6.75 | 350 | 345 |
| 7.75 | not calculated | 330 |
| 8.75 | not calculated | 315 |

As can be seen from TABLE 4, it is feasible to make symbols that resonate between 315 MHz and 630 MHz. According to an embodiment with a 5 MHz reader resolution, then 64 symbols may be used between 315 MHz and 630 MHz (e.g., 315, 320, 325, . . . , 630).

According to an embodiment, the size of the resonant structures may be cut in half to 5 mm with 5 mm spacing (and otherwise similar to the resonant structures 1100). In this embodiment, the reader has a 1-mm sense window in three dimensions (that is, the resonant structure sensed may be within 1 mm from the reader in the x-direction, the y-direction, and the z-direction). In this embodiment, the frequency band is doubled, and the number of symbols that may be used within this band is unchanged. The number of permutations is then 64 [symbol] 40=1.77×10 [symbol] 72. This embodiment may be suitable for use with a form factor having a size similar to that of a credit card (e.g., approximately 5.5 cm×8.5 cm).

TABLE 5 shows some additional information regarding the relationship between number of turns, the resonant frequency, and the return loss. The data results from a theoretical model using a square resonant structure with an outer dimension of seventeen millimeters (and otherwise identical to the resonant structure 1100).

TABLE 5

| Turns | Resonant frequency (MHz) | Return Loss (dB) |
|---|---|---|
| 1 | 1880 | 0.00115 |
| 1.25 | 955 | 0.00123 |
| 1.5 | 720 | 0.00126 |
| 1.75 | 606 | 0.00140 |
| 2 | 534 | 0.00149 |
| 2.25 | 470 | 0.00158 |
| 2.5 | 426 | 0.00168 |
| 2.75 | 392 | 0.00178 |
| 3 | 366 | 0.00186 |
| 3.25 | 342 | 0.00192 |
| 3.5 | 322 | 0.00198 |
| 3.75 | 306 | 0.00203 |
| 4 | 292 | 0.00208 |
| 4.25 | 278 | 0.00213 |
| 4.5 | 266 | 0.00212 |
| 4.75 | 258 | 0.00216 |
| 5 | 248 | 0.00222 |
| 5.25 | 240 | 0.00244 |
| 5.5 | 232 | 0.00220 |
| 5.75 | 226 | 0.00227 |
| 6 | 220 | 0.00227 |
| 6.25 | 216 | 0.00223 |
| 6.5 | 210 | 0.00231 |
| 6.75 | 206 | 0.00230 |
| 7 | 202 | 0.00230 |
| 7.25 | 198 | 0.00230 |
| 7.5 | 194 | 0.00233 |

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A radio frequency identification (RFID) apparatus comprising:
an inlay layer including a plurality of resonant metal structures having a first configuration of locations and resonant frequencies,
wherein each resonant metal structure has a location and a resonant frequency.

2. The apparatus of claim 1 wherein each of the resonant metal structures includes at least one metal loop.

3. The apparatus of claim 2 wherein the resonant metal structures include a plurality of metal extensions emanating from alternating regions of the at least one metal loop,
wherein the plurality of metal extensions form a distributed capacitance along the alternating regions of the metal loop.

4. The apparatus of claim 1 wherein the inlay layer includes a metal foil with a plurality of cavities without metal such that the metal forms the plurality of resonant metal structures.

5. A radio frequency identification system comprising:
an inlay layer including a plurality of resonant metal structures having a first configuration of locations and resonant frequencies, each resonant metal structure having a location and a resonant frequency,
an RFID reader having a plurality of metal loops, each metal loop having a location, each metal loop generating a magnetic field having a frequency,
wherein the magnetic field of each metal loop selectively couples to resonant metal structures which have a corresponding location and frequency.

6. The system of claim 5 wherein each metal loop of the RFID reader is coupled to an electrical source,
wherein the electrical source multiplexes between each metal loop.

7. The system of claim 6 wherein the electrical source sweeps over a range frequencies while sourcing an electrical signal to at least one metal loop of the RFID reader.

8. The system of claim 7 wherein the frequencies include discrete frequencies.

9. The system of claim 8 wherein the RFID reader is enabled when the inlay layer moves proximate with the plurality of resonant structures.

10. The system of claim 5 wherein a magnetic field couples to at least one resonant metal structure of the plurality of resonant metal structures,
wherein the at least one resonant metal structure has a location corresponding to a location of a metal loop of the RFID reader which induces the magnetic field,
wherein the magnetic field has a frequency corresponding to a resonant frequency of the at least one resonant metal structure.

11. The system of claim 10 wherein the metal loop of the RFID reader is coupled to an electrical source,
wherein the at least one resonant metal structure provides a load on the electrical source when the electrical source is generating the resonant frequency.

12. The system of claim 11 wherein the RFID reader detects the change of load on the electrical source when the resonant frequency of the at least one resonant metal structure is generated.

13. The system of claim 10 wherein the metal loop of the RFID reader is coupled to an electrical source,
wherein the RFID reader further includes a second metal loop that senses magnetic fields.

14. The system of claim 11 wherein the RFID reader detects the change of received magnetic flux at the second metal loop when the resonant frequency of the at least one resonant metal structure is generated from the electrical source and the resonant metal structure couples the magnetic field to the second metal loop.

15. A method of performing radio frequency identification (RFID), comprising the steps of:
moving a plurality of resonant structures proximate with an RFID reader, the plurality of resonant structures having a first configuration of locations and frequencies;
reading a reader configuration code using the RFID reader, the reader configuration code corresponding to at least one resonant structure of the plurality of resonant structures;
retrieving a reader configuration file corresponding the reader configuration code, the reader configuration file containing information regarding a second configuration of location and frequencies;
configuring the RFID reader according to the second configuration;
reading an identification number using the RFID reader, the identification number corresponding to the first configuration and the second configuration;
retrieving client information corresponding to the identification number; and
moving the plurality of resonant structures away from the RFID reader.

16. The method of claim 15 wherein the step of retrieving client information includes accessing a remote server over a secure connection over the internet.

17. The method of claim 15 wherein the step of retrieving a reader configuration file includes accessing a remote server over a secure connection over the internet.

18. The method of claim 15 wherein the step of reading the identification number includes generating an electromagnetic field provided by a plurality of metal loops of the RFID reader,
wherein each electromagnetic wave of the electromagnetic field includes a frequency corresponding to the second configuration,
wherein each metal loop has a location corresponding to the second configuration,
wherein the step of configuring the RFID reader includes programming at least one electrical source according to the second configuration.

19. The method of claim 18 wherein the step of reading the identification number includes detecting the frequency of a resonant structure of the plurality of resonant structures.

20. The method of claim 19 wherein the step of reading the identification number includes detecting a side band of the frequency of a resonant structure of the plurality of resonant structures,
wherein the second configuration includes information regarding a source frequency and a sense frequency for each location.

21. The method of claim 19 wherein the step of reading the identification number includes correlating the first configuration with the second configuration,
wherein instances that match between the first and second configurations and instances that do not match between the first and second configurations form a digital code,
wherein the digital code forms the identification number.

22. The method of claim 21 further comprising:
deleting local client information in response to the step of moving the plurality of resonant structures away from the RFID reader,
wherein the step of retrieving client information includes creating the local client information.

23. The method of claim 22 further comprising:
deleting local second configuration information in response to the step of moving the plurality of resonant structures away from the RFID reader,
wherein the local second configuration information includes the reader configuration file and local data corresponding to the reader configuration file.
